(19) United States
(12) Patent Application Publication
(10) Pub. No.: US 2022/0002179 A1
(43) Pub. Date: Jan. 6, 2022

(54) METHOD OF CONTROLLING BUBBLES IN A GLASS MAKING PROCESS

(71) Applicant: CORNING INCORPORATED, CORNING, NY (US)

(72) Inventors: Laura Rose Van Cott Adkins, Corning, NY (US); Gilbert De Angelis, Lindley, NY (US); Megan Aurora DeLamielleure, Corning, NY (US); Pierre Laronze, Corning, NY (US)

(21) Appl. No.: 17/295,302

(22) PCT Filed: Nov. 12, 2019
(86) PCT No.: PCT/US2019/060993

§ 371 Date: May 19, 2021

Related U.S. Application Data
(60) Provisional application No. 62/772,247, filed on Nov. 28, 2018.

(51) Int. Cl. C03B 5/225; C03B 5/187

(52) U.S. Cl. CPC C03B 5/225; C03B 5/187

(57) ABSTRACT

Methods are disclosed for shrinking bubbles on the free surface of a volume of molten glass contained within or flowing through a vessel, thereby minimizing re-entrainment of the bubbles into the volume of molten glass and reducing the occurrence of bubbles in finished glass products produced from the molten glass. Methods of identifying a source location for the bubbles is also described.

### CROSS-REFERENCE TO RELATED APPLICATIONS

This application claims the benefit of priority of U.S. Provisional Application Ser. No. 62/772,247 filed on Nov. 28, 2018 the contents of which are relied upon and incorporated herein by reference in their entirety as if fully set forth below.

### FIELD

The present disclosure relates generally to methods for forming a glass article, and in particular for controlling bubbles by decreasing bubble size for bubbles at the surface of a volume of molten glass within a vessel.

### TECHNICAL BACKGROUND

The manufacture of optical quality glass articles, such as glass substrates used in the manufacture of lighting panels, or liquid crystal or other forms of visual displays, involves high-temperature processes that include the transport of molten glass through various passages (e.g., vessels). Some vessels can contain a free volume, for example a gaseous atmosphere above a surface of the molten glass. Bubbles that rise to the surface are commonly expected to pop quickly upon reaching the surface, thereby eliminating the bubbles, but in some instances the bubbles may not pop, thereby risking re-entrainment into the molten glass.

### SUMMARY

Methods described herein can reduce the size of gas bubbles on the surface of a glass melt. In some embodiments, this bubble size reduction can lead to collapse of the bubbles. Thus, the occurrence of bubbles (blisters) in finished glass articles can be reduced.

Accordingly, methods of controlling bubbles in a glass making process are disclosed, comprising forming a molten glass in a first vessel, flowing the molten glass into a second vessel downstream from the first vessel, the second vessel comprising a free volume over a free surface of the molten glass, the molten glass in the second vessel comprising a bubble on the free surface, and flowing a cover gas into the free volume, wherein a partial pressure of oxygen in the cover gas is less than a partial pressure of oxygen in the bubble and a relative humidity of the cover gas is equal to or less than about 1%.

A concentration of oxygen in the cover gas can be equal to or less than about 1% by volume, for example equal to or less than about 0.5% by volume, for example equal to or less than about 0.2% by volume, for example in a range from about 0.05% by volume to about 0.2% by volume, such as in a range from about 0.075% by volume to about 1.5% by volume.

The method may further comprise heating the molten glass in the second vessel to a second temperature greater than a first temperature of the molten glass in the melting vessel temperature.

In some embodiments, the heating can comprise increasing the second temperature to equal to or greater than 1600° C.

In some embodiments, the cover gas can comprise N₂. For example, a majority gas of the cover gas can be N₂. For example, the cover gas may comprise N₂ in a concentration equal to or greater than 78% by volume, for example equal to or greater than about 85% by volume, equal to or greater than about 90% by volume, equal to or greater than about 95% by volume, equal to or greater than about 98% by volume, or equal to or greater than about 99.8% by volume.

The methods may still further comprise flowing the molten glass from the second vessel to a forming apparatus and forming the molten glass into a glass article.

In other embodiments, methods of controlling bubbles in a glass making process are described, comprising forming a molten glass in a first vessel, flowing the molten glass into a second vessel downstream from the first vessel, the second vessel comprising a free volume over a free surface of the molten glass, the molten glass in the second vessel comprising a bubble on the free surface, and flowing a cover gas into the free volume, the cover gas comprising N₂ in a concentration equal to or greater than 50% by volume, O₂ in a concentration in a range from about 0.05% by volume to about 0.2% by volume, and a relative humidity equal to or less than about 1%.

In various embodiments, the cover gas can comprise N₂ in a concentration equal to or greater than 98% by volume, equal to or greater than 78% by volume, for example equal to or greater than about 85% by volume, equal to or greater than about 90% by volume, equal to or greater than about 95% by volume, equal to or greater than about 98% by volume, or equal to or greater than about 99.8% by volume.

In some embodiments, the concentration of O₂ in the cover gas can be in a range from about 0.05% by volume to about 0.2% by volume, for example in a range from about 0.075% by volume to about 0.15% by volume.

In some embodiments, the relative humidity of the cover gas can be equal to or less than about 0.1%, for example equal to or less than about 0.05%.

In some embodiments, the methods can comprise mixing a tag gas with the cover gas for determining a location in a downstream apparatus the bubble was introduced into the molten glass.

The methods may further comprise flowing the molten glass from the second vessel to a forming apparatus and forming the molten glass into a glass article, the glass article comprising a bubble.

The methods may still further comprise detecting a presence of the tag gas in the bubble.

In still other embodiments, methods of controlling bubbles in a glass making process, are disclosed comprising forming a molten glass in a first vessel, flowing the molten glass into a second vessel downstream from the first vessel, the second vessel comprising a free volume over a free surface of the molten glass, and flowing a cover gas into the free volume, the cover gas comprising N₂ in a concentration equal to or greater than 80% by volume, O₂ in a concentration in a range from about 0.05% by volume to about 0.2% by volume, a tag gas, and a relative humidity equal to or less than about 0.1%.

The tag gas can be selected from the group consisting of argon, krypton, neon, helium, and xenon.

In various embodiments, the second vessel can be a fining vessel, the cover gas can be a first cover gas, and the tag gas can be a first tag gas. The method may further comprise flowing the molten glass from the second vessel to a third vessel, and flowing a second cover gas into a free volume contained in the third vessel, the second cover gas comprising a second tag gas different than the first tag gas.

The second cover gas may further comprise N₂ in a concentration equal to or greater than 80% by volume, O₂ in a concentration in a range from about 0.05% by volume to about 0.2% by volume, and a relative humidity equal to or less than about 0.1%

The methods may still further comprise flowing the molten glass from the third vessel to a forming apparatus and forming the molten glass into a glass article, the glass article comprising a bubble.

The methods may yet further comprise detecting at least one of the first tag gas or the second tag gas in the bubble.

Additional features and advantages of the embodiments disclosed herein will be set forth in the detailed description that follows, and in part will be apparent to those skilled in the art from that description or recognized by practicing embodiments as described herein, including the detailed description which follows, the claims, as well as the appended drawings.

It is to be understood that both the foregoing general description and the following detailed description present embodiments intended to provide an overview or framework for understanding the nature and character of the embodiments disclosed herein. The accompanying drawings are included to provide further understanding, and are incorporated into and constitute a part of this specification. The drawings illustrate various embodiments of the disclosure and together with the description explain the principles and operations thereof.

### BRIEF DESCRIPTION OF THE DRAWINGS

FIG. 1 comprises a sequence of schematic illustrations of a molten glass bubble as the bubble experiences the Marangoni effect;

FIG. 2 is a schematic view of an exemplary glass making apparatus according to embodiments of the disclosure;

FIG. 3 is a cross-sectional drawing of an exemplary fining vessel comprising a gas supply tube for providing a dry cover gas to the fining vessel;

FIG. 4 is a detailed cross-sectional view of an exemplary gas supply tube for providing a dry cover gas to a fining vessel;

FIG. 5 is a cross-sectional drawing of an exemplary stirring vessel comprising an inlet for providing a dry cover gas to a stirring vessel; and

FIG. 6 is a cross sectional view of a mixing chamber arranged to mix a tag gas with a dry cover gas.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one value, and/or to “about” another value. When such a range is expressed, another embodiment includes from the one value and/or to the other value. Similarly, when values are expressed as approximations, by use of the antecedent “about,” it will be understood that the value forms another embodiment. It will be further understood that the endpoints of each of the ranges are significant both in relation to the other endpoint, and independently of the other endpoint.

Directional terms as may be used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “free volume” in the context of a conduit or other vessel containing a molten material, such as molten glass, shall be construed as referring to a volume of the conduit and/or vessel unoccupied by molten glass. More particularly, the free volume extends between a surface of the molten glass within the vessel and a top of the vessel, and may contain, for example, one or more gases or vapors. The free volume interfaces with the molten material at a “free surface” of the molten material. The molten material may be contained in the vessel, or be flowing through the vessel.

As used herein, “molten glass” shall be construed to mean a molten material which, upon cooling, can enter a glassy state. Unless otherwise indicated, the term molten glass is used, when a noun, synonymously with the term “melt”. The molten glass may form, for example, a majority silica glass, although the present disclosure is not so limited.

As used herein, the term “redox” refers to either one or both of a reducing chemical reaction or an oxidation chemical reaction.

As used herein, the terms comprise, comprises, comprising, and variations thereof, and include, includes, including, and variations thereof, are both to be construed as open-ended transitional phrases.

As used herein, a refractory material is a non-metallic material having chemical and physical properties that make them applicable for structures, or as components of systems, that are exposed to environments above about 538° C.

Blisters (bubbles) in a glass article are typically commercially undesirable can their presence can result in a reduced production yield. Bubbles in a glass article originate in the glass melt, and can be removed, for example, by a fining process where the molten glass is heated in a vessel to decrease a viscosity of the molten glass and the redox state of the molten glass is shifted to release additional oxygen into existing bubbles, causing the bubbles in the molten glass to grow. The increased buoyancy of the oxygen-enriched bubbles combined with the reduced viscosity of the molten glass facilitates a rise of the bubbles to the free surface of the molten glass, where the bubbles pop. Gas contained in the bubbles enters the free volume and can then leave the vessel, either through deliberate venting or through leaks or other outlets in the vessel. Bubbles may contain, for example, a mixture of various gases resulting from the melting process, including oxygen (O₂), sulfur dioxide (SO₂), and/or carbon dioxide (CO₂). Bubbles may further include water, for example in the form of water vapor (H₂O), or hydroxl (OH⁻).

Historically, bubble popping was assumed to occur very quickly after bubbles reached the free surface of a glass melt. However, it has been found that bubbles can persist on the surface of a melt for sufficient time that the bubbles can exchange with a gaseous atmosphere above the melt and thereafter become re-entrained within the melt.

Analysis of blisters in finished glass articles has shown a significant proportion of N₂ gas. Because the glasses investigated did not otherwise contain appreciable amounts of dissolved nitrogen, and nitrogen is a majority gas often used in the atmosphere comprising the free volume of metallic vessels to reduce oxidation of the vessel (for example, the free volume can be left open, e.g., vented, to the ambient atmosphere), it is theorized the blisters obtained their high N₂ gas content during exchange with the atmosphere in the free volume above the melt, i.e., at a free surface of the melt. This gaseous exchange requires persistence of the bubbles on the surface of the melt for a time sufficient to accommodate the gaseous exchange, and for the bubbles to re-enter the volume of molten glass and thereafter become fixed in the final glass product as blisters. Free surfaces of the molten glass that can contribute to re-entrainment may be found, for example, in fining vessels and stirring vessels, although free surfaces may be found in other vessels as well, for example conduits used to convey the molten glass from one vessel to another vessel. However, for bubbles in the melt to appear as blisters in the final glass article after reaching a free surface of the melt, the bubbles must first avoid popping as they sit on the free surface of the melt.

Within a pool of molten glass, bubble popping is preceded by drainage of the bubble membrane as the bubble sits on the surface of the melt. Drainage occurs by two principal means, regular drainage and irregular drainage. In regular drainage, the bubble membrane becomes thinner with time as the liquid comprising the bubble membrane drains back into the melt due to gravity. When sufficient material has drained from the membrane to cause the thickness of the membrane, particularly at the top of the bubble, to be reduced to a threshold thickness, the bubble pops. In irregular drainage, bands of molten material may move across the surface of the membrane, and the membrane will decrease in thickness with time much more slowly than in the case of regular drainage. Irregular drainage is thought to be caused by the Marangoni effect (Gibbs-Marangoni effect), wherein a surface tension gradient along the bubble membrane creates a flow of material from regions of low surface tension to regions of higher surface tension. The Marangoni effect can produce a flow that opposes gravity-induced drainage, keeping the bubble wall thickness, particularly at the top of the bubble, above the threshold thickness where popping occurs.

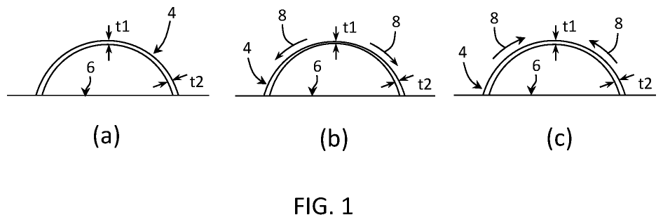

Without wishing to be bound by theory, it is thought that the high temperature within the molten glass-containing vessel, the presence of volatile constituents in the molten glass, and the generally singular (non-interconnected) nature of the bubbles on free surfaces within certain glass making processes can result in a surface tension gradient on the bubble membrane. This gradient, owing to the Marangoni effect, can produce a thickening of the bubble membrane, for example at the top of the bubble, that prolongs bubble lifetime on the surface of the melt. Referring to FIG. 1, a sequence of periods in bubble lifetime is shown. At (a), a bubble 4 is shown shortly after the bubble reaches the free surface 6 of the molten glass. Bubble 4 is illustrated with a generally consistent membrane thickness between the top thickness t1 and the base thickness t2. At (b), the bubble membrane has begun to drain back into the melt, as indicated by arrows 8 and reflected by the noticeable thinning at the top of the bubble. It should be noted that at high temperatures, various chemical constituents of the glass melt can be lost at free surfaces of the melt due to volatilization. When certain chemical constituents, such as boron, are lost, the surface tension of the molten glass is increased. Other volatile constituents can include alkali (Li, Na, K, Rb, Cs and Fr) and alkali earths (Be, Mg, Ca, Sr, Ba and Ra). Additional volatile constituents can include V, Ti and F. The volatilization of constituents from the melt is accentuated in the bubble membrane when compared with the free surface of the molten glass because the bubble membrane is largely isolated from the bulk melt and includes an atmosphere on both sides of the membrane (i.e., within the bubble and outside the bubble). More importantly, thinning of the bubble membrane at the top of the bubble during initial draining means the volatilization of constituents at the top of the bubble has a greater impact on surface tension at the top of the bubble than the volatilization of constituents at the base of the bubble membrane. This can occur at least because a given evaporation rate can alter the local melt composition faster in the thinner portion of the membrane than the thicker portion of the membrane, and therefore the thinner portion of the bubble membrane can proportionally experience a greater change in surface tension than the base of the bubble membrane. For example, the path for release of volatile constituents from an interior of the bubble membrane to a surrounding atmosphere can be shorter for the thin membrane portion than for the thicker membrane portion. The resulting surface tension gradient formed between the upper (top) portion of the bubble membrane and the base of the bubble membrane closest to the bulk melt surface is what facilitates the Marangoni effect. Accordingly, referring again to FIG. 1, at (c), the flow 8 of molten glass has reversed, with molten glass flowing to the top of the bubble rather than draining, thereby increasing the top thickness t1 compared, for example, to (b). Unaddressed, the Marangoni effect can cause and/or prolong irregular drainage and extend bubble lifetimes. It can be appreciated therefore that raising local temperatures to reduce viscosity as an aid to bubble drainage and further induce bubble popping can, conversely, worsen the Marangoni effect and extend bubble lifetime.

Past work has been directed to introducing a surfactant into the atmosphere above the molten glass, e.g., in a fining vessel or mixing apparatus, thereby promoting thinning of the bubble membrane and faster bubble popping times. For example, WO2018170392A2 describes introducing a humidified gas with high oxygen content (e.g., equal to or greater than about 10% by volume) into the vessel containing the molten glass. However, the high oxygen content may, in some instances, promote rapid oxidation of metallic vessels, for example platinum-containing vessels, at high operating temperatures.

Accordingly, as described herein below, methods are disclosed that rely on reducing, e.g., shrinking, surface bubbles rather than hastening popping. Such shrinkage can, in some instances, lead to complete bubble collapse, thereby reducing the number of bubbles available for re-entrainment in the molten glass.

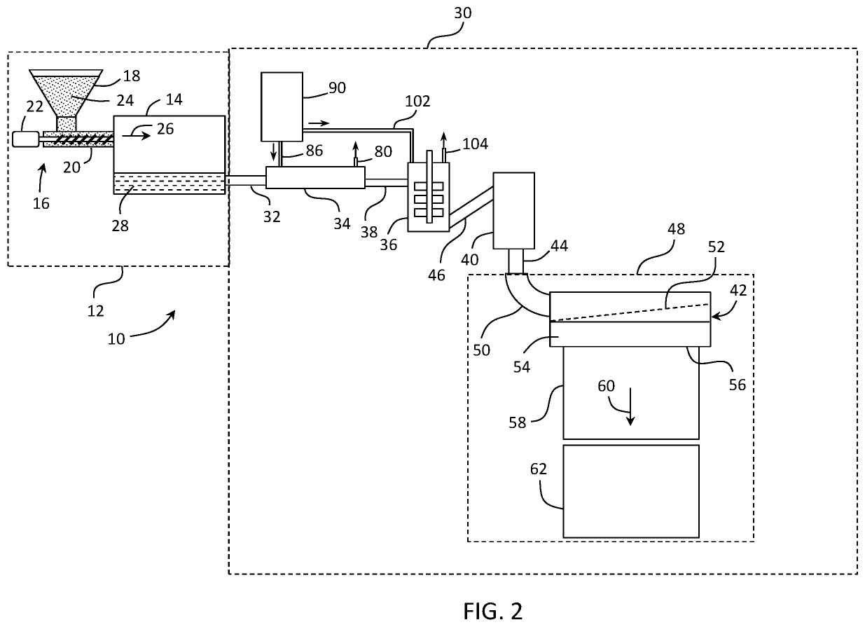

Shown in FIG. 2 is an exemplary glass manufacturing apparatus 10. In some embodiments, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners and/or electrodes) configured to heat raw material and convert the raw material into molten glass. For example, melting vessel 14 may be an electrically-boosted melting vessel, wherein energy is added to the raw material through both combustion burners and by direct heating, wherein an electric current is passed through the raw material, and thereby adding energy via Joule heating of the raw material. As used herein, an electrically-boosted melting vessel is a melting vessel that obtains heat energy from both Joule heating and above-the-glass-surface combustion heating, and the amount of energy imparted to the raw material and/or melt via Joule heating is equal to or greater than about 20% of the total energy added to the melt.

In further embodiments, glass melting furnace 12 may include thermal management devices (e.g., insulation components) that reduce heat loss from the melting vessel. In still further embodiments, glass melting furnace 12 may include electronic devices and/or electromechanical devices that facilitate melting of the raw material into a glass melt. Still further, glass melting furnace 12 may include support structures (e.g., support chassis, support member, etc.) or other components.

Glass melting vessel 14 can be formed from a refractory material, such as a refractory ceramic material, for example a refractory ceramic material comprising alumina or zirconia, although the refractory ceramic material may comprise other refractory materials, such as yttrium (e.g., yttria, yttria stabilized zirconia, yttrium phosphate), zircon (ZrSiO4) or alumina-zirconia-silica or even chrome oxide, used either alternatively or in any combination. In some examples, glass melting vessel 14 may be constructed from refractory ceramic bricks.

In some embodiments, melting furnace 12 may be incorporated as a component of a glass manufacturing apparatus configured to fabricate a glass article, for example a glass ribbon of an indeterminate length, although in further embodiments, the glass manufacturing apparatus may be configured to form other glass articles without limitation, such as glass rods, glass tubes, glass envelopes (for example, glass envelopes for lighting devices, e.g., light bulbs) and glass lenses, although many other glass articles are contemplated. In some examples, the melting furnace may be incorporated as a component of a glass manufacturing apparatus comprising a slot draw apparatus, a float bath apparatus, a down draw apparatus (e.g., a fusion down-draw apparatus), an up-draw apparatus, a pressing apparatus, a rolling apparatus, a tube drawing apparatus or any other glass manufacturing apparatus that would benefit from the present disclosure. By way of example, FIG. 2 schematically illustrates glass melting furnace 12 as a component of a fusion down draw glass manufacturing apparatus 10 for fusion drawing a glass ribbon for subsequent processing into individual glass sheets or rolling the glass ribbon onto a spool.

Glass manufacturing apparatus 10 (e.g., fusion down draw apparatus 10) can optionally include an upstream glass manufacturing apparatus 16 positioned upstream relative to glass melting vessel 14. In some examples, a portion of, or the entire upstream glass manufacturing apparatus 16, may be incorporated as part of the glass melting furnace 12.

Still referring to FIG. 2, the upstream glass manufacturing apparatus 16 can include raw material storage bin 18, raw material delivery device 20, and motor 22 connected to raw material delivery device 20. Raw material storage bin 18 can be configured to store a quantity of raw material 24 that can be fed into melting vessel 14 of glass melting furnace 12 through one or more feed ports, as indicated by arrow 26. Raw material 24 typically comprises one or more glass forming metal oxides and one or more modifying agents. Raw material 24 can also include scrap glass, e.g., cullet, from previous melting and/or forming operations. In some examples, raw material delivery device 20 can be powered by motor 22 such that raw material delivery device 20 delivers a predetermined amount of raw material 24 from the storage bin 18 to melting vessel 14. In further examples, motor 22 can power raw material delivery device 20 to introduce raw material 24 at a controlled rate based on a level of molten glass sensed downstream from melting vessel 14 relative to a flow direction of the molten glass. Raw material 24 within melting vessel 14 can thereafter be heated to form molten glass 28.

Glass manufacturing apparatus 10 can also optionally include a downstream glass manufacturing apparatus 30 positioned downstream of glass melting furnace 12 relative to a flow direction of the molten glass 28. In some examples, a portion of downstream glass manufacturing apparatus 30 may be incorporated as part of glass melting furnace 12. However, in some instances, first connecting conduit 32 discussed below, or other portions of the downstream glass manufacturing apparatus 30, may be incorporated as part of the glass melting furnace 12. Elements of the downstream glass manufacturing apparatus, including first connecting conduit 32, may be formed from a precious metal. Suitable precious metals can include platinum group metals selected from the group of metals consisting of platinum, iridium, rhodium, osmium, ruthenium and palladium, or alloys thereof. For example, downstream components of the glass manufacturing apparatus can be formed from a platinum-rhodium alloy comprising from about 70% to about 90% by weight platinum and about 10% to about 30% by weight rhodium. However, other suitable metals can include molybdenum, rhenium, tantalum, titanium, tungsten and alloys thereof.

Downstream glass manufacturing apparatus 30 can include a first conditioning (e.g., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may drive molten glass 28 through first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated in a secondary vessel to continue the melting process, or cooled to a temperature lower than the temperature of the molten glass in the primary melting vessel before entering the fining vessel.

As described previously, bubbles may be removed from molten glass 28 by various techniques. For example, raw material 24 may include multivalent compounds (e.g., fining agents) such as tin oxide that, when heated, undergo a chemical reduction reaction and release oxygen. Other suitable fining agents include without limitation arsenic, antimony, iron, and cerium, although as noted previously, the use of arsenic and/or antimony may be discouraged for environmental reasons. Fining vessel 34 can be heated to a temperature greater than the melting vessel temperature, thereby heating the fining agent. Oxygen produced by the temperature-induced chemical reduction of one or more fining agents included in the melt can coalesce or diffuse into bubbles produced in the melting furnace during the melting process, wherein the oxygen-enriched bubbles can rise through the molten glass within the fining vessel, increasing in diameter as the external pressure decreases. The enlarged gas bubbles with increased buoyancy can then rise to a free surface of the molten glass within the fining vessel, pop, and the gas therein vented out of the fining vessel. These bubbles can further induce mechanical mixing of the molten glass in the fining vessel as they rise through the molten glass.

It should be noted that bubbles at the surface of the molten glass in one or more vessels of the glass making apparatus, for example the fining vessel, generally rise as single bubbles and may form a layer of bubbles commonly no greater than a single bubble deep on the free surface of the molten glass. Some glass making processes, such as submerged combustion processes, can produce thick, persistent foam on the surface of the molten glass many bubbles deep and wherein the melt itself may include up to 30% voids. As used herein, foam is a collection of a large volume of gas separated by thin, interconnected membranes. Examples of foam are the head on a glass of beer and a bubble bath. On the other hand, bubbles reaching the free surface of the molten glass that are the subject of the present disclosure are typically singular in nature and rise through the molten glass much like bubbles in a glass of champagne, and are to be distinguished from the persistent, thick foam found in a melting furnace, or methods wherein a below-surface combustion process is being conducted. Methods described herein may be useful in addressing foam formation and persistence. However, effectiveness is reduced because only the surface layer of bubbles comprising the foam is exposed to an atmosphere in the free volume.

The downstream glass manufacturing apparatus 30 can further include another conditioning vessel, such as a mixing apparatus 36, for example a stirring vessel, for mixing the molten glass that flows downstream from fining vessel 34. Mixing apparatus 36 can be used to provide a homogenous glass melt, thereby reducing chemical or thermal inhomogeneities that may otherwise exist within the fined molten glass exiting the fining vessel. As shown, fining vessel 34 may be coupled to mixing apparatus 36 by a second connecting conduit 38. In some embodiments, molten glass 28 may be gravity fed from the fining vessel 34 to mixing apparatus 36 through second connecting conduit 38. For instance, gravity may drive molten glass 28 through second connecting conduit 38 from fining vessel 34 to mixing apparatus 36. Typically, the molten glass within the mixing apparatus includes a free surface, with a free volume extending between the free surface and a top of the mixing apparatus. It should be noted that while mixing apparatus 36 is shown downstream of fining vessel 34 relative to a flow direction of the molten glass, mixing apparatus 36 may be positioned upstream from fining vessel 34 in other embodiments. In some embodiments, downstream glass manufacturing apparatus 30 may include multiple mixing apparatus, for example a mixing apparatus upstream from fining vessel 34 and a mixing apparatus downstream from fining vessel 34. These multiple mixing apparatus may be of the same design, or they may be of a different design from one another. In some embodiments, one or more of the vessels and/or conduits may include static mixing vanes positioned therein to promote mixing and subsequent homogenization of the molten glass.

Downstream glass manufacturing apparatus 30 can further include another conditioning vessel such as delivery vessel 40 that may be located downstream from mixing apparatus 36. Delivery vessel 40 may condition molten glass 28 to be fed into a downstream forming device. For instance, delivery vessel 40 can act as an accumulator and/or flow controller to adjust and provide a consistent flow of molten glass 28 to forming body 42 through exit conduit 44. The molten glass within delivery vessel 40 can, in some embodiments, include a free surface, wherein a free volume extends upward from the free surface to a top of the delivery vessel. As shown, mixing apparatus 36 may be coupled to delivery vessel 40 by third connecting conduit 46. In some examples, molten glass 28 may be gravity fed from mixing apparatus 36 to delivery vessel 40 through third connecting conduit 46. For instance, gravity may drive molten glass 28 through third connecting conduit 46 from mixing apparatus 36 to delivery vessel 40.

Downstream glass manufacturing apparatus 30 can further include forming apparatus 48 comprising the above-referenced forming body 42, including inlet conduit 50. Exit conduit 44 can be positioned to deliver molten glass 28 from delivery vessel 40 to inlet conduit 50 of forming apparatus 48. Forming body 42 in a fusion down draw glass making apparatus can comprise a trough 52 positioned in an upper surface of the forming body and converging forming surfaces 54 (only one surface shown) that converge in a draw direction along a bottom edge (root) 56 of the forming body. Molten glass delivered to the forming body trough via delivery vessel 40, exit conduit 44 and inlet conduit 50 overflows the walls of the trough and descends along the converging forming surfaces 54 as separate flows of molten glass. It should be noted that the molten glass within the forming body trough comprises a free surface, and a free volume extends from the free surface of the molten glass to the top of an enclosure within which the forming body is positioned. The flow of molten glass down at least a portion of the converging forming surfaces is intercepted and directed by a dam and edge directors. The separate flows of molten glass join below and along a bottom edge (root) 56 of the forming body where the converging forming surfaces meet to produce a single ribbon of molten glass 58 that is drawn in a draw direction 60 from root 56 by applying a downward tension to the glass ribbon, such as by gravity, edge rolls and pulling rolls (not shown), to control the dimensions of the glass ribbon as the molten glass cools and a viscosity of the material increases. Accordingly, glass ribbon 58 goes through a visco-elastic transition and acquires mechanical properties that give glass ribbon 58 stable dimensional characteristics. Glass ribbon 58 may in some embodiments be separated into individual glass sheets 62 by a glass separation apparatus (not shown) in an elastic region of the glass ribbon, while in further embodiments, the glass ribbon may be wound onto spools and stored for further processing.

Embodiments of the present disclosure will now be described in the context of a fining vessel, with the understanding that such embodiments are not limited to a fining vessel and may be applied to other vessels comprising a free volume overtop the free surface of a volume of molten glass, such vessels including stirring vessels, delivery vessels, and other vessels and/or conduits that contain and/or convey molten glass and may include a free volume over the melt. As used hereinafter, the term “vessels” will be considered to encompass both processing vessels, for example fining vessels and stirring vessels, and conduits connecting such discrete processing vessels.

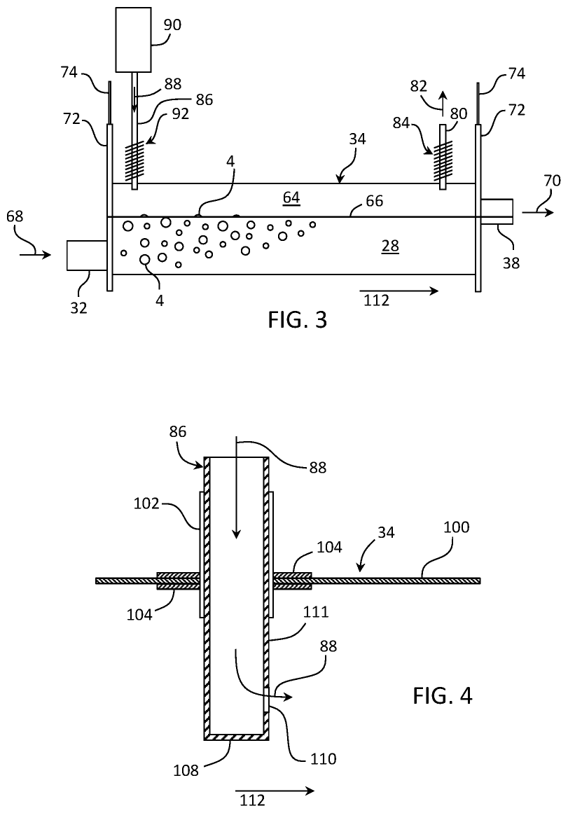

FIG. 3 is a cross-sectional side view of an exemplary fining vessel 34. Fining vessel 34 comprises a volume of molten glass 28 flowing therethrough, and a gaseous atmosphere contained within free volume 64 positioned above free surface 66 of molten glass 28. Molten glass flows into fining vessel 34 at a first end, as indicated by arrow 68, and flows out of fining vessel 34 at an opposing second end, as indicated by arrow 70. For example, molten glass can flow into fining vessel 34 via connecting conduit 32, and out of fining vessel 34 via connecting conduit 38. The molten glass within the fining vessel can be heated to a temperature greater than the melting temperature, for example in a range from about 1600° C. to about 1700° C., such as in a range from about 1650° C. to 1700° C., typically by an electric current established within the vessel itself, although in further embodiments, the fining vessel can be heated by other means, for example by external heating elements (not shown). In some embodiments, the molten glass may be heated to a temperature greater than 1700° C., such as up to about 1720° C.

As shown in FIG. 3, fining vessel 34 can comprise electrical flanges 72, for example at least two electrical flanges, in electrical communication with an electrical power source (not shown) through respective electrode portions 74 such that an electrical current is established between the electrical flanges and within the intervening wall or walls of the fining vessel. In some embodiments, a multitude of electrical flanges may be used, for example three electrical flanges, four electrical flanges, or even five electrical flanges or more, wherein the fining vessel and/or attached connecting conduits can be divided into a plurality of temperature zones by differential localized heating of the temperature zones between electrical flanges. The increased buoyancy of the bubbles due to bubble growth, and reduced viscosity of the molten glass resulting from the raised temperature, increases upward force on the bubbles and decreases resistance to the ascent of bubbles 4 within the molten glass, thereby facilitating the rise of the bubbles to free surface 66. At free surface 66, the bubbles may pop, and the gas contained therein released into free volume 64. For example, gases contain in the bubbles can include oxygen (O₂), sulfur dioxide (SO₂) and carbon dioxide (CO₂). The bubbles may further contain water (H₂O). In various embodiments, because of the oxygen enrichment of bubbles due to oxygen release by the fining agent, a majority component of the bubble interiors may be oxygen. The gas released by bubble popping may, in some embodiments, be vented out of the fining vessel via optional vent tube 80, as indicated by arrow 82. Vent tube 80 is shown in a vertical orientation and entering fining vessel 34 at the top of the fining vessel, the orientation and position of vent tube 80 is not limited in this regard. For example, vent tube 80 could be oriented horizontally and enter the fining vessel along a side thereof, or in any other suitable orientation, angle, or position. In some embodiments, vent tube 80 may be heated, for example by one or more heating elements such as external electrical resistance heating element(s) 84, although in further embodiments, vent tube 80 may be heated by establishing an electrical current directly within the vent tube in a manner similar to fining vessel 34. However, as further described, some bubbles reaching free surface 66, may not pop during even a prolonged residence time at free surface 66 for reasons previously described, and may become re-entrained within the molten glass flowing through the fining vessel.

In accordance with embodiments described herein, a dry cover gas 88 provided from gas source 90 can be injected into free volume 64 above free surface 66 via fining vessel gas supply tube 86 such that the dry gas “covers” the molten glass in the vessel. While fining vessel gas supply tube 86 is shown in a vertical orientation and entering fining vessel 34 at the top of the fining vessel, the orientation and position of fining vessel gas supply tube 86 is not limited in this regard. For example, fining vessel gas supply tube 86 could be oriented horizontally and enter the fining vessel along a side thereof, or in any other suitable orientation, angle, or position. Cover gas 88 can, in various embodiments, comprise a relative humidity equal to or less than about 1%, for example equal to or less than about 0.5%, equal to or less than about 0.1%, or equal to or less than about 0.05%, such as zero percent (0%), and can further comprise inert gas, for example nitrogen, although in further embodiments, the inert gas may be a noble gas such as helium, neon, argon, krypton, xenon, etc., or combinations of any of the preceding inert gases.

The average oxygen (O₂) content of cover gas 88 supplied to fining vessel 34 should be less than the oxygen content in the bubbles to ensure outward diffusion of oxygen from the bubbles. That is, the partial pressure of oxygen in the cover gas outside the bubbles should be less than the partial pressure of oxygen within the bubbles. For example, in various embodiments, cover gas 88 supplied to fining vessel 34 may comprise an O₂ content equal to or less than 0.2% by volume, for example in a range from about 0.05 by volume to about 0.2% by volume, such as in a range from about 0.075% by volume to about 1.5% by volume. There should be sufficient oxygen in the cover gas to prevent reduction of the platinum-comprising walls of the fining vessel due to a high nitrogen concentration in the cover gas. However, the concentration of oxygen should be sufficiently low as to prevent damaging oxidation of the platinum-comprising walls. Accordingly, in various embodiments, cover gas 88 can be a majority nitrogen gas comprising oxygen in a range from about 0.05% by volume to about 0.2% by volume, and comprising a relative humidity equal to or less than about 0.5%. In other embodiments, cover gas 88 can be a majority nitrogen gas comprising oxygen in a range from about 0.075% by volume to about 0.15% by volume, and comprising a relative humidity equal to or less than about 0.1%. In still other embodiments, cover gas 88 can be a majority nitrogen gas comprising oxygen in a range from about 0.075% by volume to about 0.15% by volume, and comprising a relative humidity equal to or less than about 0.05%. In some embodiments, the cover gas may comprise N₂ in a concentration equal to or greater than 78% by volume, for example equal to or greater than about 85% by volume, equal to or greater than about 90% by volume, equal to or greater than about 95% by volume, equal to or greater than about 98% by volume, or equal to or greater than about 99.8% by volume.

The low oxygen, low humidity atmosphere provided to free volume 64 via cover gas 88 can produce a net flow of gas and/or vapor from within bubbles on the surface of molten glass 28 within fining vessel 34 across the bubble membrane into free volume 64, where, as previously stated, the released gas and/or vapor (e.g., water vapor) can exit free volume 64 through vent 80. The release of gas and/or vapor that diffuses from the bubbles across the bubble membranes can result in shrinkage of the bubbles. Shrinkage may make the bubbles too small to be re-entrained into the flow of molten glass, allowing the bubbles more time to pop. In some embodiments, such shrinkage can result in complete collapse of the bubbles.

A flow rate of cover gas 88 can be in a range from equal to or greater than about 1 (one) turnover per minute to equal to or less than about 1 turnover per hour, including all ranges and subranges therebetween. As used herein, “turnover” means a flow rate equivalent to the volume of the free volume per unit time. As an example, for a 1 cubic meter volume, 1 turnover per minute means a gas flow rate equal to 1 cubic meter per minute. A gas supplied to a 4 cubic meter volume at a rate of 2 turnovers per minute means a flow rate of 8 cubic meters per minute. The flow rate selected will depend on the size of the free volume supplied with the enrichment gas. The flow rate of cover gas can be, for example, in a range from about 0.02 turnovers per minute to about 1 turnover per minute, in a range from about 0.05 turnovers per minute to about 1 turnover per minute, in a range from about 0.1 turnovers per minute to about 1 turnover per minute, in a range from about 0.5 turnovers per minute to about 1 turnover per minute, or in a range from about 0.8 turnovers per minute to about 1 turnover per minute, and including all ranges and subranges therebetween.

In some embodiments, fining vessel gas supply tube 86 may be heated, thereby heating cover gas 88 supplied to fining vessel 34. For example, fining vessel gas supply tube 86 and thereby cover gas 88 may be heated by one or more heating elements such as external electrical resistance heating element(s) 92, although in further embodiments, fining vessel gas supply tube 86 may be heated by establishing an electrical current directly within the fining vessel gas supply tube in a manner similar to the method of heating fining vessel 34. For example, fining vessel gas supply tube 86 may include one or more electrical flanges in electrical communication with an electrical power source as described in respect of fining vessel 34.

FIG. 4 is a cross sectional view of an exemplary fining vessel gas supply tube 86 shown penetrating a wall 100 of fining vessel 34 above the free surface 66 of molten glass 28 (not shown). Fining vessel gas supply tube 86 is shown extending through a reinforcing sleeve 102 where the fining vessel gas supply tube penetrates fining vessel wall 100. In addition, reinforcing plates 104 are depicted adjacent reinforcing sleeve 102 and located above and below fining vessel wall 100 and attached thereto. Reinforcing plates 104, reinforcing sleeve 102 and fining vessel wall 100 can be attached to each other, such as by welding. For example, reinforcing plates 104 can be welded to fining vessel wall 100 and to reinforcing sleeve 102. In addition, in embodiments, reinforcing sleeve 102 can be welded to fining vessel gas supply tube 86. Reinforcing plates 104 and reinforcing sleeve 102 provide additional thickness and rigidity to the fining vessel wall and fining vessel gas supply tube 86 where the fining vessel gas supply tube penetrates the fining vessel, since all can be formed of thin sheets of a platinum alloy and easily deformed as the metal expands during initial heating up of the system.

Fining vessel gas supply tube 86 may further comprise a closed bottom 108 and an exhaust port 110 located on side wall 111 of the fining vessel gas supply tube near the bottom of the fining vessel gas supply tube and oriented such that cover gas 88 can be exhausted from fining vessel gas supply tube 86 in a direction generally parallel with a flow direction 112 of the molten glass within fining vessel 34 (e.g., oriented in a downstream direction). Generally parallel flow of cover gas 88 and molten glass 28 can minimize or eliminate direct impingement of cover gas 88 being exhausted from the gas supply tube onto free surface 66 of the molten glass and avoid cooling of the molten glass free surface. Such cooling can cause viscosity inhomogeneities in the molten glass that can manifest as defects in the finished product. In addition, a side-ported gas supply tube reduces the probability that condensates, such as glass constituents like easily-volatilized boron, can accumulate in the exhaust port and eventually drop into the molten glass below.

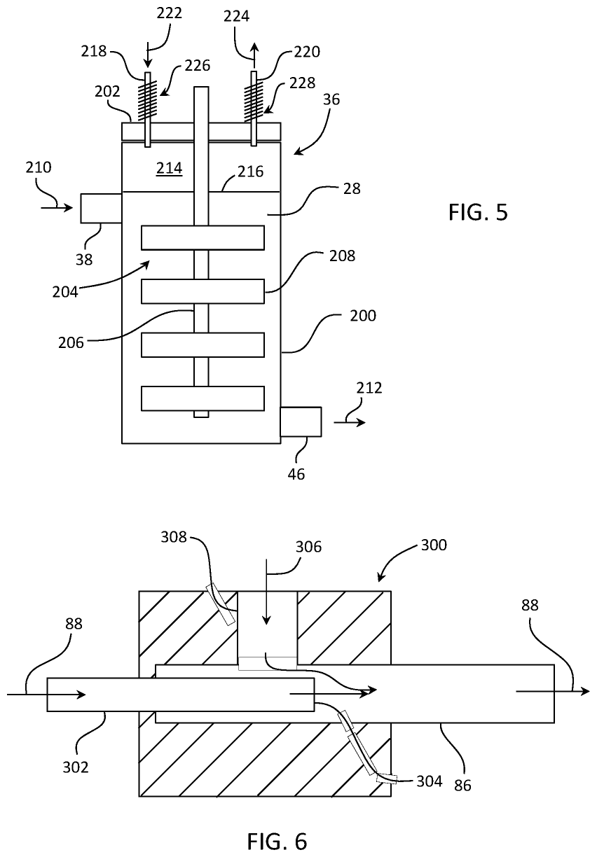

In some embodiments, mixing apparatus 36 may be supplied with cover gas 88, alternatively or in addition to fining vessel 34. FIG. 5 is a cross sectional view of an exemplary mixing apparatus 36. Mixing apparatus 36 can include stirring vessel 200 and a stirring vessel cover 202 positioned overtop stirring vessel 200. Mixing apparatus 36 may further comprise a stirrer 204 rotatably mounted within stirring vessel 200, stirrer 204 including a shaft 206 extending through stirring vessel cover 202 and a plurality of mixing blades 208 extending from shaft 206, at least a portion of stirrer 204 immersed in molten glass 28. Shaft 206 may be coupled to a motor (not shown), for example by a chain or gear drive apparatus used to rotate the stirrer. In the embodiment illustrated in FIG. 5, molten glass enters stirring vessel 200 via conduit 38, flows downward between the mixing blades of the rotating stirrer, and exits via conduit 46, as indicated by arrows 210 and 212, respectively. A free volume 214 may be positioned and maintained between a free surface 216 of molten glass 28 and vessel cover 202.

Mixing apparatus 36 may further comprise a stirring vessel gas supply tube 218 and an optional stirring vessel vent tube 220. In embodiments, one or both of stirring vessel gas supply tube 218, or stirring vessel vent tube 220 if present, can be arranged to extend through stirring vessel cover 202 and open into free volume 214 above free surface 216. While stirring vessel gas supply tube 218 and stirring vessel vent tube 220 are shown in a vertical orientation and entering through stirring vessel cover 202, the orientation, angle, or position of stirring vessel gas supply tube 218 and/or stirring vessel vent tube 220 is not limited in this regard. Cover gas 88 can be injected into the free volume 214 above free surface 216 within stirring vessel 200 via stirring vessel gas supply tube 218 as indicated by arrow 222. As with the fining vessel, the partial pressure of oxygen in the cover gas supplied to free volume 214 can be equal to or less than the partial pressure of oxygen within the bubbles residing on free surface 216.

A flow rate of cover gas 88 can be in a range from equal to or greater than about 1 (one) turnover per minute to equal to or less than about 1 turnover per hour, including all ranges and subranges therebetween. As used herein, “turnover” means a flow rate equivalent to the volume of the free volume per unit time. As example, for a 1 cubic meter volume, 1 turnover per minute means a gas flow rate equal to 1 cubic meter per minute. A gas supplied to a 4 cubic meter volume at a rate of 2 turnovers per minute means a flow rate of 8 cubic meters per minute. The flow rate will depend on the size of the free volume supplied with the enrichment gas. For example, the flow rate can be in a range from about 0.02 turnovers per minute to about 2 turnovers per minute, in a range from about 0.05 turnovers per minute to about 1 turnover per minute, in a range from about 0.1 turnovers per minute to about 1 turnover per minute, in a range from about 0.5 turnovers per minute to about 1 turnover per minute, or in a range from about 0.8 turnovers per minute to about 1 turnover per minute, including all ranges and subranges therebetween. Gases within free volume 214 of stirring vessel 200 above free surface 216 can be exhausted through stirring vessel vent tube 220, as indicated by arrow 224. In some embodiments, the flow rate can be in a range from about 1 standard liter per minute (slpm) to about 50 slpm, for example in a range from about 1 slpm to about 30 slpm.

It should be noted that although a fining agent is unlikely to provide significant oxygen bubbles while in the stirring vessel, bubbles may still rise to the surface of the molten glass within the stirring vessel, for example bubbles originating from within the melting vessel, or even bubbles re-entrained during the fining process. Additionally, volatilization of certain glass constituents, such as boron, can still occur within the stirring vessel.

In embodiments, stirring vessel gas supply tube 218 may be heated, thereby heating cover gas 88 supplied to stirring vessel 200. For example, stirring vessel gas supply tube 218, and thereby cover gas 88, may be heated by one or more heating elements such as external electrical resistance heating element(s) 226, although in further embodiments, stirring vessel gas supply tube 218 may be heated by establishing an electric current directly within the stirring vessel gas supply tube. In some embodiments, stirring vessel vent tube 220, if present, may be heated, for example by one or more heating elements such as external electrical resistance heating element(s) 228, although in further embodiments, stirring vessel vent tube 220 may be heated by establishing an electric current directly within the stirring vessel vent tube. In some embodiments, a stirring vessel vent tube may not be needed, wherein venting is obtained through leaks, e.g., between stirring vessel cover 202 and stirring vessel 200.

In some embodiments, a non-reactive gas, for example a noble gas such as argon, krypton, neon, or xenon, or another non-reactive gas, can be added to a cover gas at a predetermined concentration, for example a cover gas injected into the free volume in the finer or the cover gas injected into a free volume in a stirring vessel, as an aid to identifying a source of blisters in a finished glass article resulting from the glass manufacturing process. That is, bubbles in the molten glass can be tagged with a detectable quantity of a non-reactive gas as a means of determining a location for the bubble formation. For example, a specific first non-reactive gas (hereinafter “tag” gas) can be added to a cover gas supplied to fining vessel 34, for example a gas mixing chamber in fluid communication with the respective vessel gas supply tube (e.g., fining vessel gas supply tube 86). Suitable tag gases can include, but are not limited to, argon, krypton, neon, helium, and xenon. An exemplary gas mixing chamber is illustrated in FIG. 6, wherein cover gas 88 is supplied to gas mixing chamber 300 via supply line 302 extending into and opening within gas supply tube 86 at open end 304. The flow of cover gas from open end 304 into gas supply tube 86 creates a low-pressure region at open end 304 that draws tag gas 306 from tag gas supply passage 308 (in fluid communication with gas supply tube 86) into gas supply tube 86, where tag gas 306 mixes with cover gas 88. After tag gas 308 is mixed with cover gas 88, cover gas 88 can be supplied to fining vessel 34. However, various other gas mixing apparatus as known to those of ordinary skill in the art may be used.

Blisters found in a finished glass article can be analyzed, for example by mass spectrometry, to determine if the first tag gas is present in the blisters at a concentration consistent with the concentration of the first tag gas added to the cover gas supplied to the fining vessel, thereby identifying the source of blisters as the fining vessel. However, a tag gas concentration found in blisters inconsistent with the concentration of the tag gas supplied to the fining vessel may indicate the source of the blisters is not the fining vessel. Similarly, a second tag gas different from the first tag gas can be added to a cover gas supplied to a different vessel, for example the stirring vessel. An analysis of blisters in the glass article can then be used to determine the number of blisters containing the first tag gas, if any, and/or the number of blisters containing the second tag gas, if any, thereby providing better identification and quantification of the source of the blisters. If, for example the second tag gas is found, but not the first tag gas, then the source of blisters may be inferred to come from the vessel into which the second tag gas was injected. The presence of both the first tag gas and the second tag gas in a bubble may indicate the bubble survived transportation between several vessels and reside on the surface of the molten glass in both vessels.

The tag gas or gases are typically not the majority gas comprising the cover gas. For example, if the majority gas (>50%) comprising the cover gas is N₂, the cover gas may comprise less than 50% tag gas, wherein the tag gas is different than the majority gas.

It will be apparent to those skilled in the art that various modifications and variations can be made to embodiments of the present disclosure without departing from the spirit and scope of the disclosure. For example, while the preceding description centered on fining vessels and stirring vessels, the embodiments described herein can be applied to other vessels comprising molten glass with a free surface, such as delivery vessel 40, using flow rates and gas compositions as described above for fining and stirring vessels. Thus, it is intended that the present disclosure cover such modifications and variations provided they come within the scope of the appended claims and their equivalents.

1. A method of controlling bubbles in a glass making process, comprising:
flowing a cover gas into a free volume of a vessel containing molten glass, the molten glass comprising a free surface with a bubble located on the free surface, wherein a partial pressure of oxygen in the cover gas is less than a partial pressure of oxygen in the bubble, and a relative humidity of the cover gas is equal to or less than about 1%.

2. The method according to claim 1, wherein a concentration of oxygen in the cover gas is equal to or less than about 1% by volume.

3. The method according to claim 2, wherein the concentration of oxygen is in a range from about 0.05% by volume to about 0.2% by volume.

4. The method according to claim 1, wherein the cover gas comprises N₂.

5. The method according to claim 4, wherein a concentration of the N₂ in the cover gas is equal to or greater than about 98% by volume.

6. The method according to claim 1, further comprising forming the molten glass into a glass article.

7. A method of controlling bubbles in a glass making process, comprising:
forming a molten glass in a first vessel;
flowing the molten glass into a second vessel downstream from the first vessel, the second vessel comprising a free volume over a free surface of the molten glass, the molten glass in the second vessel comprising a bubble on the free surface; and
flowing a cover gas into the free volume, wherein a partial pressure of oxygen in the cover gas is less than a partial pressure of oxygen in the bubble, and a relative humidity of the cover gas is equal to or less than about 1%.

8. The method according to claim 7, wherein a concentration of oxygen in the cover gas is equal to or less than about 1% by volume.

9. The method according to claim 8, wherein the concentration of oxygen is in a range from about 0.05% by volume to about 0.2% by volume.

10. The method according to claim 7, wherein the molten glass in the melting vessel comprises a first temperature, the method further comprising heating the molten glass in the second vessel to a second temperature greater than the first temperature.

11. The method according to claim 10, wherein the second temperature is equal to or greater than 1600° C.

12. The method according to claim 7, wherein the cover gas comprises N₂.

13. The method according to claim 12, wherein a concentration of the N₂ in the cover gas is equal to or greater than about 98% by volume.

14. The method according to claim 7, further comprising flowing the molten glass from the second vessel to a forming apparatus and forming the molten glass into a glass article.

15. A method of controlling bubbles in a glass making process, comprising:
forming a molten glass in a first vessel;
flowing the molten glass into a second vessel downstream from the first vessel, the second vessel comprising a free volume over a free surface of the molten glass; and
flowing a cover gas into the free volume, the cover gas comprising N₂ in a concentration equal to or greater than 50% by volume, O₂ in a concentration in a range from about 0.05% by volume to about 0.2% by volume, and a relative humidity equal to or less than about 1%.

16. The method according to claim 15, wherein the cover gas comprises N₂ in a concentration equal to or greater than 98% by volume.

17. The method according to claim 16, wherein the concentration of O₂ in the cover gas is in a range from about 0.05% by volume to about 0.15% by volume.

18. The method according to claim 17, wherein the relative humidity of the cover gas is equal to or less than about 0.1%.

19. The method according to claim 15, further comprising mixing a tag gas with the cover gas prior to flowing the cover gas into the free volume.

20. The method according to claim 19, further comprising:
flowing the molten glass from the second vessel to a forming apparatus and forming the molten glass into a glass article, the glass article comprising a bubble; and
detecting a presence of the tag gas in the bubble.

21.-27. (canceled)
